(19) United States
(12) Patent Application Publication
(10) Pub. No.: US 2026/0049037 A1
(43) Pub. Date: Feb. 19, 2026

(54) METHOD FOR MANUFACTURING AMORPHOUS CERAMICS

(71) Applicant: Hongik University Industry-Academia Cooperation Foundation, Seoul (KR)

(72) Inventors: Dongwook LEE, Seoul (KR); Dong Gyu KIM, Seoul (KR); Kyeonghun JEONG, Seoul (KR); Bin HUR, Seoul (KR); Kyunghyun KIM, Seoul (KR)

(21) Appl. No.: 19/193,639

(22) Filed: Apr. 29, 2025

(30) Foreign Application Priority Data
Aug. 16, 2024 (KR) 10-2024-0110083
Apr. 3, 2025 (KR) 10-2025-0043585

(51) Int. Cl. C04B 35/626

(52) U.S. Cl. CPC C04B 35/62625; C04B 35/62655; C04B 2235/3272; C04B 2235/3279; C04B 2235/38; C04B 2235/447

(57) ABSTRACT

The present disclosure provides a method for manufacturing amorphous ceramics. The method includes preparing a precursor solution including at least one cation, a first anion and a solvent; rapid drying the precursor solution to obtain an intermediate in the form of a powder or thin film; and performing an anion-exchange of the intermediate, wherein the first anion of the intermediate is exchanged for a second anion to obtain amorphous ceramics including the second anion.

### CROSS-REFERENCE TO RELATED APPLICATION(S)

This application claims the priority benefit of Korean Patent Application No. 10-2024-0110083, filed on Aug. 16, 2024, and Korean Patent Application No. 10-2025-0043585, filed on Apr. 3, 2025, at the Korean Intellectual Property Office, the entire disclosure of which is incorporated herein by reference for all purposes.

### BACKGROUND

### 1. Field

The present disclosure relates to a method for manufacturing amorphous ceramics through rapid drying and ion-exchange.

### 2. Description of Related Art

Conventional methods for manufacturing amorphous ceramics use melt quenching, which involves melting a ceramic material at a high temperature to make it in a liquid phase and then rapidly cooling it. However, there is a problem that unintended partial crystallization occurs during the rapid cooling (quenching) process, resulting in phase separation. In addition, these methods require high temperature conditions of 400-2000° C. to melt all the constituent metal elements that make up the ceramic; on account of this, these methods also have the problems of increasing the carbon footprint and the cost of the process.

The ball-milling process that applies mechanical energy to amorphize the ceramic powder has also been used as a method for manufacturing amorphous ceramics; however, the composition of amorphous powders produced by the ball-milling process is non-uniform, and partial crystallization may not be ruled out; so there is a concern that 100% amorphization may not be achieved.

Therefore, there is a need for a controllable method for fabricating amorphous ceramics containing various metal cations and anions at lower temperatures uniformly.

### SUMMARY

The technical goal to be achieved by the present disclosure is to provide a method for manufacturing amorphous ceramics containing various metal cations and anions, the method not requiring high temperature conditions of 400° C. or higher and the rapid cooling process.

In an aspect for achieving the technical goal, the present disclosure provides a method for manufacturing amorphous ceramics, the method including:
preparing a precursor solution including at least one cation, a first anion and a solvent;
rapid drying the precursor solution to obtain an intermediate in the form of a powder or thin film; and
performing an anion-exchange of the intermediate, wherein the first anion of the intermediate is exchanged for a second anion to obtain amorphous ceramics including the second anion.

As used herein, it shall be understood that the term “about” refers to a range of numbers that one of ordinary skill in the art would consider equivalent to the stated value in terms of achieving the same function or result. When the term “about” is used in conjunction with a number or value, the term “about” refers to ±20% of that number or value, usually ±10% of that number or value, often ±5% of that number or value, or ±2% of that number or value. In some embodiments, the term “about”may refer to the number or value itself.

All numerical ranges given throughout this specification include their upper and lower limits, and all narrower numerical ranges falling within such ranges, and all such narrower numerical ranges are considered to be expressly and specifically set forth herein.

In this specification, even if there is no expression that explicitly indicates whether a noun is singular or plural, such as “a(n),” “one,” or “˜s,” the noun always means “at least one” or “one or more”and also includes the plural form of the noun.

The method for manufacturing amorphous ceramics according to the present disclosure may provide a uniform amorphous ceramic without requiring a high temperature condition of 400° C. or higher and a rapid cooling process. In addition, the method for manufacturing amorphous ceramics according to the present disclosure may be utilized without any limits on the selection of components consisting of the ceramic, particularly on the selection of metal cations. Therefore, there is an advantage in that the method may be used to manufacture amorphous ceramics having various metal cations.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 schematically illustrates the process of a method for manufacturing amorphous ceramics according to the present disclosure;

FIG. 2 illustrates the spray drying process;

FIG. 3 shows a comparison of XRD data of amorphous ceramics produced according to Preparation Example 1 and its crystalline ceramics; and

FIG. 4 shows XRD data of amorphous ceramics produced according to Preparation Example 2.

### DETAILED DESCRIPTION

Hereinafter, embodiments will be described in detail with reference to the accompanying drawings. However, various alterations and modifications may be made to the embodiments. Thus, the scope of the present patent application shall not be construed as limited or circumscribed by such embodiments. With respect to the embodiments, it should be understood that the scope of the present disclosure shall include all changes, equivalents, and replacements.

The terminology used herein is for the purpose of describing particular embodiments only and is not to be construed as limiting. The singular forms “a,” “an,” and “the” include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as is commonly understood by one of ordinary skill in the art to which the examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In addition, when describing the embodiments with reference to the accompanying drawings, like reference numerals refer to like constituent elements and duplicate descriptions related thereto have been omitted. In the description of embodiments, detailed descriptions of well-known related art have been omitted where it was deemed that such descriptions will cause ambiguous interpretation of the present disclosure.

In addition, terms such as first, second, A, B, (a), (b), and the like may be used to describe components of the embodiments. These terms are used only for the purpose of discriminating one constituent element from another constituent element, and the nature, the sequences, or the orders of the constituent elements are not limited by these terms.

An element included in one embodiment and an element having a function in common with it, will be described using the same designation in descriptions of other embodiments. Unless otherwise indicated, the description of one embodiment may be applicable to other embodiments and thus, duplicate descriptions have been omitted for conciseness.

Research on eco-friendly energy is being actively conducted, and one of the most promising technologies is technology for harnessing hydrogen energy. Hydrogen has the advantage of being environmentally friendly because water is produced during the its combustion process and having a higher energy density than petroleum or natural gas. On account of this, technologies for supplying hydrogen itself to be used as an energy source are also gaining attention, and research is underway on water-electrolysis technology, which electrolyzes water to produce oxygen and hydrogen. A catalyst is required to prevent the overvoltage of water during the water-electrolysis process, and materials such as crystalline iridium oxide are widely used as water-electrolysis catalysts.

Recently, many attempts have been made to utilize amorphous ceramic materials as water-electrolytic catalysts. The reason for this is that the diffusion rate of any materials such as ions inside amorphous materials is faster than the diffusion rate inside crystalline materials; and amorphous materials have a better ability to store ions than crystalline materials, so using amorphous materials as catalysts may increase catalytic activity. Therefore, there is a need for the production of amorphous ceramics for the development of water electrolysis catalysts. In particular, materials having a chemical composition such as metal hydroxides may be utilized as water-electrolytic catalysts, and methods are being devised to provide amorphous ceramics having such compositions in a more convenient and controllable manner.

Furthermore, the application of amorphous ceramics is not limited to the field of water electrolysis catalysts. Due to the free volume, an inherent property of the amorphous materials described above, the diffusion rate of any materials like ions inside amorphous materials is faster than the diffusion rate inside crystalline materials, so amorphous materials have better ability to store ions and other materials than crystalline materials. Hence, attempts are continuously being made to utilize amorphous materials in the field of secondary batteries and their solid electrolytes.

In crystalline materials, on the other hand, the relative sizes of cations and anions, and the resultant permissible arrangement of atoms within a three-dimensional space, are very important factors that determine the crystal structure. Thus, not all cations and anions in all arithmetically possible combinations and composition ratios will form stable crystalline materials. Crystalline materials are highly constrained in their composition, as they may have composition ratios for cations and anions only within the allowable range limited by their respective crystal structures. On the other hand, amorphous materials have fewer of these constraints, and thus the advantages of amorphous materials are emerging in many aspects.

In light of these circumstances, the present disclosure provides a method for manufacturing amorphous ceramics, which may be utilized for manufacturing amorphous ceramics having various compositions. In addition, the manufacturing method according to the present disclosure does not require high temperature conditions of 400° C. or higher, and amorphous ceramics may be easily manufactured without problems such as phase separation.

The present disclosure provides a method for manufacturing amorphous ceramics, the method including:
preparing a precursor solution including at least one cation, a first anion and a solvent;
rapid drying the precursor solution to obtain an intermediate in the form of a powder or thin film; and
performing an anion-exchange of the intermediate, wherein the first anion of the intermediate is exchanged for a second anion to obtain amorphous ceramics including the second anion.

Hereinafter, a method for manufacturing an amorphous ceramic according to the present disclosure will be described in detail.

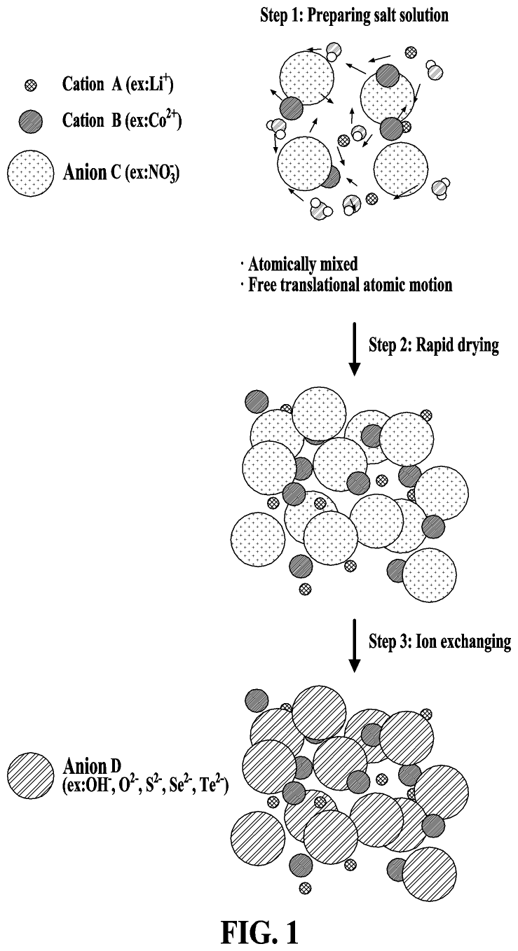

A method for manufacturing amorphous ceramics according to the present disclosure is schematically shown in FIG. 1.

In one embodiment, the step of preparing the precursor solution may include mixing a salt including the at least one metal cation and the first anion with a solvent.

In one embodiment, the at least one cation may include two or more cations. That is, the precursor solution may contain two or more different types of metal cations, for example, two, three, four, or five types of metal cations may be contained in the precursor solution. The at least one cation is a cation that constitutes the final ceramic material. Thus, the metal cation may be freely selected from various metal cations according to the intended use of the amorphous ceramic. The metal cation refers to the cation of any element in the periodic table that may be cationized. Preferably, the metal cation may be selected from the group consisting of cations of transition metal (e.g., Ni, Fe, Co, Cr, Mn, Cu, Zn, Zr, Ti, V, Y cations), cations of rare earth metal (e.g., La, Ce, Pr, Nd, Sm, Eu, Gd cations), cations of transuranium metal (e.g., Np, Pu, Cm cations), cations of noble metal (e.g., Ag, Au, Pt, Pd, Rh, Ru, Ir cations), cations of alkali metal (e.g., Li, Na, K, Rb, Cs cations), cations of alkaline earth metal (e.g., Sr, Mg, Ca, Be, Ba cations), cations of Group 13 metal (e.g., Al, Ga, In, Tl cations), and a combination thereof. More preferably, when there are more than two metal cations in the precursor solution, the metal cations may be a combination of cations of a transition metal, cations of a rare earth metal, cations of a transuranium metal, and cations of a noble metal. In one embodiment, the metal cation may be selected from the group consisting of Ni²⁺, Fe²⁺, Fe³⁺, Li⁺, Co²⁺, Co³⁺, K⁺, Cr³⁺, Cr⁶⁺, Mn²⁺, Mn³⁺, Mn⁷⁺, Cu²⁺, Al³⁺, Zn²⁺, Zr⁴⁺, Ti³⁺, Ti⁴⁺, La³⁺, Sr²⁺, V²⁺, V³⁺, V⁴⁺, V⁵⁺, Y³⁺, La³⁺, Ce³⁺, Ce⁴⁺, Pr³⁺, Nd³⁺, Sm³⁺, Eu³⁺, Gd³⁺, Np³⁺, Np⁴⁺, Np⁵⁺, Np⁶⁺, Pu³⁺, Pu⁴⁺, Pu⁵⁺, Pu⁶⁺, Cm³⁺, Ag⁺, Au³⁺, Pt²⁺, Pt⁴⁺, Pd²⁺, Pd⁴⁺, Rh³⁺, Ru³⁺, Ir³⁺, Li⁺, Na⁺, Rb⁺, Cs⁺, Sr²⁺, Mg²⁺, Ca²⁺, Be²⁺, Ba²⁺, Ga³⁺, In³⁺, Tl⁺, and a combination thereof. In one embodiment, the metal cation may include two or more cations, and may include, for example, Ni²⁺and Fe^{3+.}

Since the first anion will be replaced with the second anion after the rapid drying step, the first anion is not an anion element that is comprised of the final ceramic material. Thus, any first anion may be freely used, so long as it is provided in the form of a salt together with the metal cation and is well dissolved in a solvent. In one embodiment, the first anion may be selected from the group consisting of halide anion (e.g., fluoride anion, chloride anion, bromide anion, iodide anion), sulfate anion (SO₄²⁻), nitrate anion (NO₃⁻), acetate anion (CH₃COO⁻), carbonate anion (CO₃²⁻), citrate anion (C₆H₅O₇³⁻), phosphate anion (PO₄³⁻), pyrophosphate anion (P₂O₇⁴⁻), halogen oxoanion (ClO₃⁻, ClO₄⁻ etc.), bis(trifluoromethylsulfonyl)imide anion ((CF₃SO₂)₂N⁻), triflate anion (CF₃SO₃⁻), BF₄⁻, PF₆⁻, AsF₆⁻, bis(fluorosulfonyl)amide anion (FSA⁻), TFSI⁻, BETI⁻, lactate anion (CH₃CH(OH)COO⁻), formate anion (HCOO⁻), propionate anion (C₂H₅COO⁻), alkyl sulfate anion (e.g., methyl sulfate anion (CH₃OSO₃⁻)), dicyanamide anion (N(CN)₂⁻), thiocyanate anion (SCN⁻), trifluoroacetate anion (CF₃COO⁻), palmitate anion (C₁₅H₃₁COO⁻), stearate anion (C₁₇H₃₅COO⁻), oleate anion (C₁₇H₃₃COO⁻), tartrate anion (C₄H₄O₆²⁻), benzoate anion (C₆H₅COO⁻), phthalate anion (C₆H₄(COO)₂²⁻), salicylate anion (C₆H₄(OH)COO⁻), oxalate anion (C₂O₄²⁻), malonate anion (CH₂(COO)₂²⁻), succinate anion (C₂H₄(COO)₂²⁻), and a combination thereof. In one embodiment, the first anion may be chloride anion. Although various examples of first anions are presented in this specification, whether or not they may be used as first anions may depend on the combination of the metal cation and the first anion. This means that even for the same anion, if the anion dissolves well in a solvent (e.g., water) when used with any metal cation, then it may be used as a first anion; whereas if the anion does not dissolve well in a solvent (e.g., water) when used with another metal cation, then it may not be used as a first anion. Therefore, depending on the type of metal cation used, a first anion that is well soluble in the solvent when used together with the metal cation may be selected and used.

Any solvent capable of dissolving the metal cation and the first anion may be freely used. In one embodiment, the solvent may be selected from the group consisting of water; alcohols such as methanol, ethanol, propanol, butanol, glycerol, and ethylene glycol; carbonate solvents such as acetone, acetonitrile, dimethyl sulfoxide (DMSO), dimethyl carbonate (DMC), ethyl methyl carbonate (EMC), diethyl carbonate (DEC), ethylene carbonate (EC), and propylene carbonate (PC); tetrahydrofuran (THF), acetic acid (CH₃COOH), 1-methyl-2-pyrrolidinone (NMP), dimethylformamide (DMF), dimethylacetamide (DMAc), formamide; glyme solvents such as diglyme, triglyme, and tetraglyme; dioxane (C₄H₈O₂), gamma-butyrolactone (GBL, C₄H₆O₂), dimethoxyethane (DME), dioxolane, diethylether (DEE), methyl formate, methyl propionate, sulfolane and a combination thereof. In one embodiment, the solvent may be water.

In one embodiment, the concentration of the cation in the precursor solution may be from about 0.1 M to about 5 M, preferably from about 0.5 M to about 2 M. If there are more than two metal cations, the concentrations of each cation may be different.

In one embodiment, the solubility of the metal cation and the first anion in the solvent may be from 1 mM to 56 M.

The step of rapid drying the precursor solution produces an amorphous intermediate. In one embodiment, the rapid drying may be spray drying or air knife drying. When spray drying is used, a powder form intermediate is obtained; when air knife drying is used, a thin-film form intermediate is obtained.

Air knife drying is a method in which a precursor solution is formed into a precursor thin film of a predetermined thickness and then the film is rapidly dried by spraying dry gas. That is, the solvent in the precursor solution may be evaporated by spraying dry gas onto the top surface of the precursor thin film. The dry gas may be air or an inert gas such as nitrogen gas or argon gas. In one embodiment, the air knife drying may be performed at a temperature of about 20° C. to about 350° C.

In one embodiment, the precursor solution may be coated on a flat substrate to produce a precursor thin film having a predetermined thickness (100 μm or less) that may satisfy a drying time. The precursor solution may be coated on a flat substrate by spraying, by roll coating using a gravure coater, a slot die coater, a blade coater or a reverse coater, or by inkjet. The flat substrate may be a rigid substrate such as a glass substrate. In addition, the flat substrate may be a flexible substrate such as a resin film. The flat substrate may be heated to a predetermined substrate temperature. The substrate temperature may be from about 20° C. to about 350° C. In addition, the precursor solution may be heated to a predetermined solution temperature and used. The solution temperature may be from about 20° C. to about 350° C. The drying time may be within about 10 seconds. In addition, the drying time may be from about 0.1 to about 10 seconds. Preferably, the drying time may be from about 0.1 to about 1 second. More preferably, the drying time may be within about 1 second. Therefore, the rapid drying may be performed under the condition that the solvent in the precursor thin film is evaporated within the drying time. Hence, the precursor thin film may be dried more quickly.

Air knife rapid drying may be performed by spraying dry gas onto the top surface of the precursor thin film using an air knife. The dry gas may be sprayed such that the precursor thin film is dried within a complete drying time. The dry gas may be sprayed at a wind speed of about 0.5 to about 30 m/s. The dry gas may also be heated to a temperature of from about 20° C. to about 350° C. and sprayed. Preferably, the dry gas may be heated to a temperature of from about 50° C. to about 250° C. and sprayed. The air knife may be supplied with dry gas in a compressed state and may spray it through a spray nozzle of a predetermined length. The air knife may spray dry gas over an area of a predetermined width and length. The air knife may spray dry gas over an area having a length greater than a width of the precursor thin film. The air knife drying may be performed such that the air knife sprays dry gas onto the top surface of the precursor thin film while the continuously formed precursor thin film moves in a direction downward of the air knife. Hence, the air knife rapid drying may be performed as a continuous process.

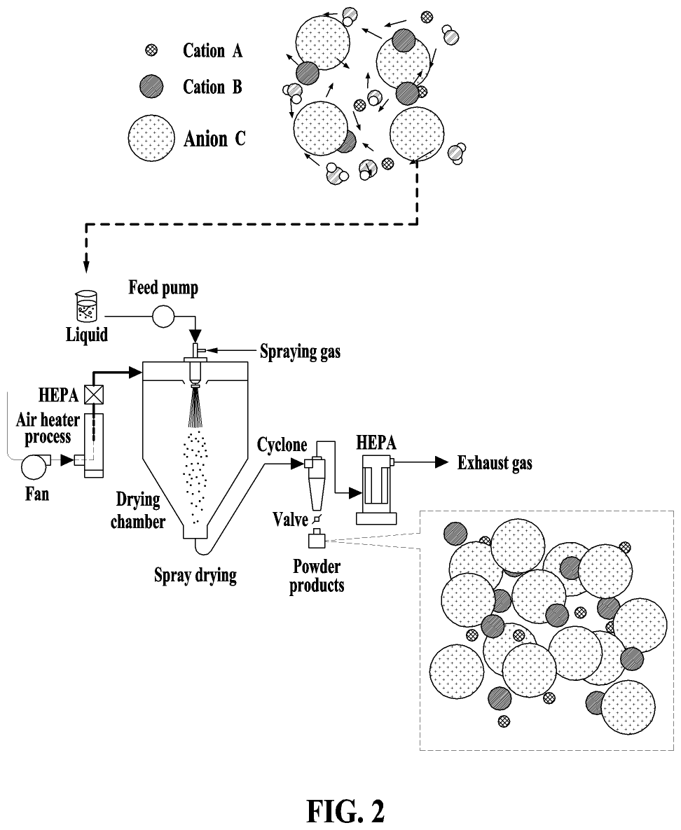

On the other hand, spray drying is a method in which a precursor solution is sprayed in the form of a mist into the air, and the mist is dried and become powders while in contact with a heated gas (FIG. 2). The heated gas may be air or an inert gas such as nitrogen gas or argon gas. In one embodiment, spray drying may be performed at a temperature of about 25° C. to about 400° C., preferably about 70° C. to about 350° C., more preferably about 70° C. to about 250° C.

The spray drying may be performed by spraying the precursor solution as a mist with a spray dryer. The dry gas may be introduced such that the precursor mist is dried to produce a precursor powder within a complete drying time. The dry gas may be introduced into the spray dryer at a wind speed of from about 0.1 to about 30 m/s. In addition, the dry gas may be heated to a temperature of about 25° C. to about 400° C., preferably about 70° C. to about 250° C., and contacted with the precursor mist. The spray dryer may be supplied with dry gas in a compressed state and may spray it through a spray nozzle of a predetermined length. The spray drying may be contacted with a precursor mist that is formed continuously. Hence, the spray drying may be performed as a continuous process.

Before rapid drying, each ion or atom in the precursor solution is in translational motion, which is a basic property that ions and molecules dissolved in liquids have in common. However, these liquid properties are rapidly removed by rapid drying the precursor solution. As the liquid precursor solution is rapidly dried, the precursor is converted into a solid, amorphous material in a manner similar to a glass phase transition. The rapid drying step takes place in a very short time, and there is no time for nucleation and crystallization, so that an amorphous material having atomic-level uniformity may be produced without partial crystallization and phase separation.

The rapid drying may completely dry the precursor thin film within a drying time. Here, the term “completely dry” may mean that the 90% or more of content of solvent in the precursor thin film is removed by drying process. The drying time may be within about 10 seconds. In addition, the drying time may be from about 0.1 to about 10 seconds. Preferably, the drying time may be from about 0.1 to about 1 second. More preferably, the drying time may be within about 1 second. Therefore, the rapid drying may be performed under the condition that the solvent in the precursor thin film is evaporated within the drying time.

The second anion is comprised of the final amorphous ceramic material. Thus, the second anion may be selected from various anions according to the intended use of the amorphous ceramic. In one embodiment, the second anion may be selected from the group consisting of hydroxide anion (OH⁻), phosphate anion (PO₄³⁻), pyrophosphate anion (P₂O₇⁴⁻), sulfide anion (S²⁻), carbonate anion (CO₃²⁻), sulfate anion (SO₄²⁻), silicate anion (SiO₄⁴⁻, SiO₃²⁻ etc.), borate anion (BO₃³⁻, B₄O₇²⁻ etc.), selenide anion (Se²⁻), tellurium anion (Te²⁻), nitride anion (N³⁻), carbonized anion (C⁴⁻) and a combination thereof. In one embodiment, the second anion may be hydroxide anion (OH⁻) or phosphate anion (PO₄³⁻).

In one embodiment, the second anion may be an anion that does not dissolve in a solvent (e.g., water) and forms a precipitate when provided into the solvent together with the metal cation. In other words, if a metal cation and a second anion are initially introduced into a solvent in the form of a salt of the metal cation and the second anion at the beginning without undergoing an anion exchange process, but the metal cation and the second anion are insoluble in the solvent, they cannot be amorphized by a rapid drying process. The method of the present disclosure is very useful for such cases, i.e., useful for amorphizing a ceramic including such a combination of the second anion and the metal cation. This is because the amorphization of the ceramic may be realized by selecting a first anion that, when provided with a corresponding metal cation, is highly soluble in a solvent; performing rapid drying with this first anion; and then replacing the first anion with a second anion.

In one embodiment, the anion exchange step may include adding the intermediate to a solution including a second anion. The solution containing the second anion may be obtained by adding a salt of the second anion and an inactive cation to a solvent. In one embodiment, the second anion that may be added in this manner is, for example, hydroxide anion (OH⁻), phosphate anion (PO₄³⁻), pyrophosphate anion (P₂O₇⁴⁻), carbonate anion (CO₃²⁻), sulfate anion (SO₄²⁻), silicate anion (SiO₄⁴⁻, SiO₃²⁻ etc.), borate anion (BO₃³⁻, B₄O₇²⁻ etc.) and a combination thereof. The inactive cation may be any cations, without limitation, as long as it is soluble in the solvent when added to the solvent together with the second anion, for example, alkali metal cations such as Li⁺, Na⁺, K⁺, Rb⁺, Cs⁺; NH₄⁺; quaternary ammonium such as tetramethyl ammonium, tetraethyl ammonium, tetrapropyl ammonium, and tetrabutyl ammonium; imidazolium, pyridinium, pyrrolidinium, chollinium, phosphonium, oxonium, sulfonium, quaternary phosphonium, pyrisdinium, pipyridinium, morpholinium, quinolinium, and a combination thereof. The solvent used in the anion-exchange step may be the same as or different from the solvent in the precursor solution. The solvent used in the anion exchange step may be selected from the group consisting of water; alcohols such as methanol, ethanol, propanol, butanol, glycerol, and ethylene glycol; carbonate solvents such as acetone, acetonitrile, dimethyl sulfoxide (DMSO), dimethyl carbonate (DMC), ethyl methyl carbonate (EMC), diethyl carbonate (DEC), ethylene carbonate (EC), and propylene carbonate (PC); tetrahydrofuran (THF), acetic acid (CH₃COOH), 1-methyl-2-pyrrolidinone (NMP), dimethylformamide (DMF), dimethylacetamide (DMAc), formamide; glyme solvents such as diglyme, triglyme, and tetraglyme; dioxane (C₄H₈O₂), gamma-butyrolactone (GBL, C₄H₆O₂), dimethoxyethane (DME), dioxolane, diethylether (DEE), methyl formate, methyl propionate, sulfolane and a combination thereof. In one embodiment, the solvent may be water.

In one embodiment, the concentration of the second anion in the solution containing the second anion may be from about 0.01 to about 50 M, preferably from about 0.1 to about 40 M, more preferably from about 1 to about 35 M.

In one embodiment, the anion exchange step may be completed within 1 hour, preferably 5 to 30 minutes, more preferably 5 to 10 minutes, after adding the solution including the second anion.

In one embodiment, the anion exchange process may be performed two or more times, for example, two to five times.

In one embodiment, the anion exchange step may include introducing a liquid or gas including the second anion into the precursor, or introducing a liquid or gas including elemental form of the second anion materials into the precursor. In one embodiment, the liquid or gas may be introduced using a precursor used in the chemical vapor deposition (CVD) including atomic layer deposition (ALD).

In one embodiment, the method according to the present disclosure may include a step of drying the amorphous ceramic material obtained after anion exchange. In one embodiment, the drying step may be performed using vacuum drying.

The entire process of the method according to the present disclosure may be performed at a temperature of 350° C. or less. Therefore, the present method has the advantage of being able to amorphize the ceramic material at relatively low temperatures. In addition, the method according to the present disclosure may obtain a ceramic in a uniformly amorphous state without partial crystallization, etc. Thus, there are no problems such as phase separation.

Throughout this specification, “percent (%),” which is used to indicate the concentration of a particular material, is (weight/weight) % for solid/solid, (weight/volume) % for solid/liquid, and (volume/volume) % for liquid/liquid, unless otherwise indicated.

### Preparation Example 1: Preparation of Ni_{0.75}Fe_{0.25}(OH)ₓ Amorphous Powder (Preparation Example 1-1) and Ni_{0.75}Fe_{0.25}(PO₄)ₓ Amorphous Powder (Preparation Example 1-2)

### 1) Preparing a Precursor

NiCl₂·6H₂O (14.262 g) and FeCl₃·6H₂O (5.406 g) was added to distilled water (60 g) and mixed to prepare a one-pot solution (total concentration of NiCl₂ and FeCl₃: 1.333 mol/kg).

The solution was dried by spray drying. Specifically, the solution was introduced into a spray nozzle installed in a spray dryer (Xiamen Ollital Technology Co., Ltd, model number: OLT-SD8000B) at a flow rate of 400 mL/hr. The temperature of the inlet chamber was set to 200° C.

After spray drying was completed, an amorphous powder of Ni_{0.75}Fe_{0.25}Cl_{2.25}·xH₂O composition was obtained at room temperature. The powder was stored in an Ar-filled glove box (moisture level<0.1 ppm) or a vacuum desiccator to prevent further moisture absorption.

### 2) Anion Exchange Process and Purification

To prevent the elution of Ni or Fe from the amorphous powder, 2 g of the obtained amorphous powder was added to a NaOH solution (aqueous solution in which 4 g NaOH is dissolved in 100 mL of distilled water) with a pH set to pH=14, and the amorphous powder was anion-exchanged for OH⁻. Similarly, to prevent the elution of Ni or Fe from the amorphous powder, 2 g of the obtained amorphous powder was added to a saturated Na₃PO4 solution (solution in which 28 g of Na₃PO4 is dissolved in 100 mL of distilled water) and the amorphous powder was anion-exchanged for PO4³⁻. The mixture was stirred and then spun in a centrifuge at 9000 RPM for 20 minutes. Only the settled powder was selected. Then, the supernatant was discarded and the selected powder was washed three times with distilled water in its place. After the powder was washed, the powder was vacuum dried (using JEIO TECH's OV4-S product) at room temperature to prevent crystallization to obtain powders with the desired Ni_{0.75}Fe_{0.25}(OH)ₓ amorphous composition (Preparation example 1-1) and Ni_{0.75}Fe_{0.25}(PO₄)ₓ amorphous composition (Preparation example 1-2), respectively.

### Preparation Example 2

### 1) Preparation Example 2-1

The processes of precursor preparation, anion exchange and purification used for this example were the same as the ones used for Preparation example 1, except that MnCl₂·4H₂O (3.96 g) was added to the initial one-pot solution to obtain Ni_{0.75}Fe_{0.25}Mn_{0.50}(OH)ₓ as an amorphous powder.

### 2) Preparation Example 2-2

The processes of precursor preparation, anion exchange and purification used for this example were the same as the ones used for Preparation example 1, except that CrCl₃·6H₂O (5.33 g) was added to the initial one-pot solution to obtain Ni_{0.75}Fe_{0.25}Cr_{0.50}(OH)ₓ as an amorphous powder.

### Experimental Example 1: Xrd Measurement

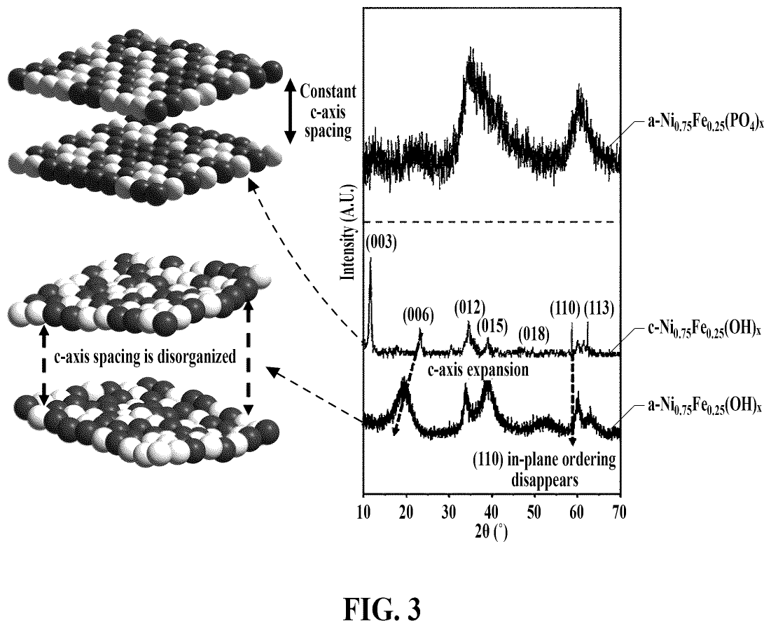

The amorphous powder obtained in Preparation Example 1 was placed in an XRD holder. Since anion-exchanged amorphous powder is not hygroscopic, 1 g or more of the amorphous powder was loaded into the XRD holder in the air. The XRD was measured. Then, the amorphousness was confirmed, as shown in FIG. 3. For comparison, XRD data of crystalline nickel iron layer double hydroxide (NiFe LDH) is also shown. From the fact that the XRD data of the powder of Preparation Example 1 does not show X-ray diffraction peaks that the crystalline structure of NiFe LDH has, it can be seen that the powder of Preparation Example 1 retains its amorphous structure after anion exchange.

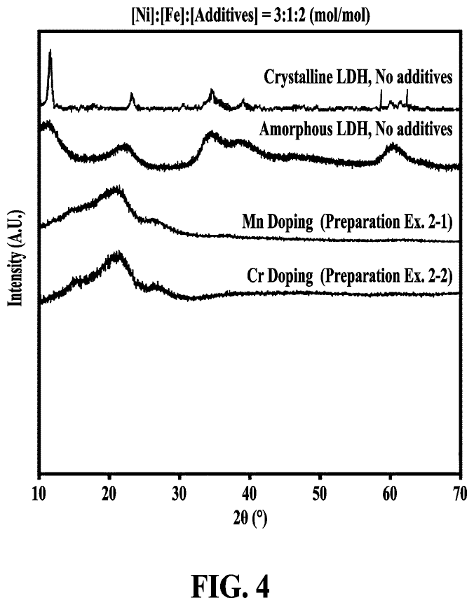

The XRD of the amorphous powder obtained in Preparation Example 2 was measured using the same method. The result is shown in FIG. 4. From the fact that the XRD data of the powder of Preparation Example 2 does not show X-ray diffraction peaks that the crystalline structure of NiFe LDH has, it can be seen that the powder of Preparation Example 2 retains its amorphous structure after anion exchange.

Although a number of embodiments have been described with reference to limited drawings, one of ordinary skill in the art will recognize that various modifications and alterations may be made to these embodiments based on the above detailed description. For example, suitable results may be achieved if the described techniques are performed in a different order, and/or if components in a described system, architecture, device, or circuit are combined in a different manner, and/or replaced or supplemented by other components or their equivalents.

Therefore, other implementations, other examples, and equivalents to the claims are also within the scope of the following claims.

The present disclosure provides the following embodiments:

### Embodiment 1

A method for manufacturing amorphous ceramics, the method including:
preparing a precursor solution including at least one cation, a first anion and a solvent;
rapid drying the precursor solution to obtain an intermediate in the form of a powder or thin film; and
performing an anion-exchange of the intermediate, wherein the first anion of the intermediate is exchanged for a second anion to obtain amorphous ceramics including the second anion.

### Embodiment 2

The method of aspect 1, wherein the rapid drying is spray drying or air knife drying.

### Embodiment 3

The method of any one of the aforementioned embodiments, wherein the first anion is selected from the group consisting of halide anion, sulfate anion (SO₄²⁻), nitrate anion (NO₃⁻), acetate anion (CH₃COO⁻), carbonate anion (CO₃²⁻), citrate anion (C₆H₅O7³⁻), phosphate anion (PO₄³⁻), pyrophosphate anion (P₂O₇⁴⁻), halogen oxoanion, bis(trifluoromethylsulfonyl)imide anion ((CF₃SO₂)₂N⁻), triflate anion (CF₃SO₃⁻), BF₄⁻, PF₆⁻, AsF₆⁻, bis(fluorosulfonyl)amide anion (FSA⁻), TFSI⁻, BETI⁻, lactate anion (CH₃CH(OH)COO⁻), formate anion (HCOO⁻), propionate anion (C₂H₅COO⁻), alkyl sulfate anion, dicyanamide anion (N(CN)₂⁻), thiocyanate anion (SCN⁻), trifluoroacetate anion (CF₃COO⁻), palmitate anion (C₁₅H₃₁COO⁻), stearate anion (C₁₇H₃₅COO⁻), oleate anion (C₁₇H₃₃COO⁻), tartrate anion (C₄H₄O₆²⁻), benzoate anion (C₆H₅COO⁻), phthalate anion (C₆H₄(COO)₂²⁻), salicylate anion (C₆H₄(OH)COO⁻), oxalate anion (C₂O₄²⁻), malonate anion (CH₂(COO)₂²⁻), succinate anion (C₂H₄(COO)₂²⁻), and combinations thereof.

### Embodiment 4

The method of any one of the aforementioned embodiments, wherein the first anion is a chloride anion.

### Embodiment 5

The method of any one of the aforementioned embodiments, wherein the second anion is selected from the group consisting of hydroxide anion (OH⁻), phosphate anion (PO₄³⁻), pyrophosphate anion (P₂O₇⁴⁻), sulfide anion (S²⁻), carbonate anion (CO₃²⁻), sulfate anion (SO₄²⁻), SiO₄⁴⁻, SiO₃²⁻, BO₃³⁻, B₄O₇²⁻, selenide anion (Se²⁻), tellurium anion (Te²⁻), nitride anion (N³⁻), carbonized anion (C⁴⁻) and combinations thereof.

### Embodiment 6

The method of any one of the aforementioned embodiments, wherein the second anion is a hydroxide anion (OH⁻).

### Embodiment 7

The method of any one of the aforementioned embodiments, wherein the at least one cation comprises two or more cations.

### Embodiment 8

The method of any one of the aforementioned embodiments, wherein the cation is selected from the group consisting of Ni²⁺, Fe²⁺, Fe³⁺, Li⁺, Co²⁺, Co³⁺, K⁺, Cr³⁺, Cr⁶⁺, Mn²⁺, Mn³⁺, Mn⁷⁺, Cu²⁺, Al³⁺, Zn²⁺, Zr⁴⁺, Ti³⁺, Ti⁴⁺, La³⁺, Sr²⁺, V²⁺, V³⁺, V⁴⁺, V⁵⁺, Y³⁺, La³⁺, Ce³⁺, Ce⁴⁺, Pr³⁺, Nd³⁺, Sm³⁺, Eu³⁺, Gd³⁺, Np³⁺, Np⁴⁺, Np⁵⁺, Np⁶⁺, Pu³⁺, Pu⁴⁺, Pu⁵⁺, Pu⁶⁺, Cm³⁺, Ag⁺, Au³⁺, Pt²⁺, Pt⁴⁺, Pd²⁺, Pd⁴⁺, Rh³⁺, Ru³⁺, Ir³⁺, Li⁺, Na⁺, Rb⁺, Cs⁺, Sr²⁺, Mg²⁺, Ca²⁺, Be²⁺, Ba²⁺, Ga³⁺, In³⁺, Tl⁺, and combinations thereof.

### Embodiment 9

The method of any one of the aforementioned embodiments, wherein the at least one cation is Ni²⁺ and Fe³⁺.

### Embodiment 10

The method of any one of the aforementioned embodiments, wherein the solvent is selected from the group consisting of water, methanol, ethanol, propanol, butanol, glycerol, ethylene glycol, acetone, acetonitrile, dimethyl sulfoxide (DMSO), dimethyl carbonate (DMC), ethyl methyl carbonate (EMC), diethyl carbonate (DEC), ethylene carbonate (EC), propylene carbonate (PC), tetrahydrofuran (THF), acetic acid (CH₃COOH), 1-methyl-2-pyrrolidinone (NMP), dimethylformamide (DMF), dimethylacetamide (DMAc), formamide, diglyme, triglyme, tetraglyme, dioxane (C₄H₈O₂), gamma-butyrolactone (GBL, C₄H₆O₂), dimethoxyethane (DME), dioxolane, diethylether (DEE), methyl formate, methyl propionate, sulfolane and combinations thereof.

### Embodiment 11

The method of any one of the aforementioned embodiments, wherein the spray drying is performed at a temperature of from 70° C. to 350° C.

What is claimed is:

1. A method of manufacturing amorphous ceramics, the method comprising:
preparing a precursor solution comprising at least one cation, a first anion and a solvent;
rapid drying the precursor solution to obtain an intermediate in the form of a powder or thin film; and
performing an anion-exchange of the intermediate, wherein the first anion of the intermediate is exchanged for a second anion to obtain amorphous ceramics comprising the second anion.

2. The method of claim 1, wherein the rapid drying is spray drying or air knife drying.

3. The method of claim 1, wherein the first anion is selected from a group consisting of halide anion, sulfate anion (SO₄²⁻), nitrate anion (NO₃⁻), acetate anion (CH₃COO⁻), carbonate anion (CO₃²⁻), citrate anion (C₆H₅O₇³⁻), phosphate anion (PO₄³⁻), pyrophosphate anion (P₂O₇⁴⁻), halogen oxoanion, bis(trifluorosulfonyl)imide anion ((CF₃SO₂)₂N⁻), triflate anion (CF₃SO₃⁻), BF₄⁻, PF₆⁻, AsF₆⁻, bis(fluorosulfonyl)amide anion (FSA⁻), TFSI⁻, BETI⁻, lactate anion (CH₃CH(OH)COO⁻), formate anion (HCOO⁻), propionate anion (C₂H₅COO⁻), alkyl sulfate anion dicyanamide anion (N(CN)₂⁻), thiocyanate anion (SCN⁻), trifluoroacetate anion (CF₃COO⁻), palmitate anion (C₁₅H₃₁COO⁻), stearate anion (C₁₇H₃₅COO⁻), oleate anion (C₁₇H₃₃COO⁻), tartrate anion (C₄H₄O₆²⁻), benzoate anion (C₆H₅COO⁻), phthalate anion (C₆H₄(COO)₂²⁻), salicylate anion (C₆H₄(OH)COO⁻), oxalate anion (C₂O₄²⁻), malonate anion (CH₂(COO)₂²⁻), succinate anion (C₂H₄(COO)₂²⁻), and a combination thereof.

4. The method of claim 1, wherein the first anion is chloride anion.

5. The method of claim 1, wherein the second anion is selected from a group consisting of hydroxide anion (OH⁻), phosphate anion (PO₄³⁻), pyrophosphate anion (P₂O₇⁴⁻), sulfide anion (S²⁻), carbonate anion (CO₃²⁻), sulfate anion (SO₄²⁻), SiO₄⁴⁻, SiO₃²⁻, BO₃³⁻, B₄O₇²⁻, selenide anion (Se²⁻), tellurium anion (Te²⁻), nitride anion (N³⁻), carbonized anion (C⁴⁻) and a combination thereof.

6. The method of claim 1, wherein the second anion is hydroxide anion (OH⁻).

7. The method of claim 1, wherein the at least one cation comprises two or more cations.

8. The method of claim 1, wherein the cation is selected from a group consisting of Ni²⁺, Fe²⁺, Fe³⁺, Li⁺, Co²⁺, Co³⁺, K⁺, Cr³⁺, Cr⁶⁺, Mn²⁺, Mn³⁺, Mn⁷⁺, Cu²⁺, Al³⁺, Zn²⁺, Zr⁴⁺, Ti³⁺, Ti⁴⁺, La³⁺, Sr²⁺, V²⁺, V³⁺, V⁴⁺, V⁵⁺, Y³⁺, La³⁺, Ce³⁺, Ce⁴⁺, Pr³⁺, Nd³⁺, Sm³⁺, Eu³⁺, Gd³⁺, Np³⁺, Np⁴⁺, Np⁵⁺, Np⁶⁺, Pu³⁺, Pu⁴⁺, Pu⁵⁺, Pu⁶⁺, Cm³⁺, Ag⁺, Au³⁺, Pt²⁺, Pt⁴⁺, Pd²⁺, Pd⁴⁺, Rh³⁺, Ru³⁺, Ir³⁺, Li⁺, Na⁺, Rb⁺, Cs⁺, Sr²⁺, Mg²⁺, Ca²⁺, Be²⁺, Ba²⁺, Ga³⁺, In³⁺, Tl⁺, and a combination thereof.

9. The method of claim 1, wherein the at least one cation is Ni²⁺ and Fe³⁺.

10. The method of claim 1, wherein the solvent is selected from a group consisting of water, methanol, ethanol, propanol, butanol, glycerol, ethylene glycol, acetone, acetonitrile, dimethyl sulfoxide (DMSO), dimethyl carbonate (DMC), ethyl methyl carbonate (EMC), diethyl carbonate (DEC), ethylene carbonate (EC), propylene carbonate (PC), tetrahydrofuran (THF), acetic acid (CH₃COOH), 1-methyl-2-pyrrolidinone (NMP), dimethylformamide (DMF), dimethylacetamide (DMAc), formamide, diglyme, triglyme, tetraglyme, dioxane (C₄H₈O₂), gamma-butyrolactone (GBL, C₄H₆O₂), dimethoxyethane (DME), dioxolane, diethylether (DEE), methyl formate, methyl propionate, sulfolane and a combination thereof.

11. The method of claim 2, wherein the spray drying is performed at a temperature of from 70° C. to 350° C.
